(19) United States
(12) Patent Application Publication
(10) Pub. No.: US 2022/0190865 A1
(43) Pub. Date: Jun. 16, 2022

(54) DEVICE FOR SAFELY SUPPORTING MOBILE PHONE

(71) Applicant: Hyeen-Chool JUNG, Seoul (KR)

(72) Inventor: Hyeen-Chool JUNG, Seoul (KR)

(21) Appl. No.: 17/605,583

(22) PCT Filed: Apr. 22, 2020
(86) PCT No.: PCT/KR2020/005339

§ 371 Date: Oct. 22, 2021

(30) Foreign Application Priority Data
Apr. 22, 2019 (KR) 10-2019-0046509
Nov. 20, 2019 (KR) 10-2019-0149973

(51) Int. Cl. H04B 1/3888; H04M 1/06; A45C 11/00

(52) U.S. Cl. CPC H04B 1/3888; A45C 2011/002; A45C 11/00; H04M 1/06

(57) ABSTRACT

According to the present disclosure,
one or more of a connection ring, a connection string, and beads are selectively separably connected to a band for supporting a mobile phone with a finger inserted therein, so a user can present his/her more individual and aesthetic decoration.

Further, a support plate insertion hole for applying a mobile phone support configuration is formed at the center of the rear side of an existing mobile phone or mobile phone case such that a band support plate having the band insertion hole for inserting the band is inserted and supported by a locking step formed at the support plate insertion hole or the band support plate.

Accordingly, it is possible to more easily support and use a mobile phone equipped with the mobile phone support configuration while keeping the mobile phone thin without manufacturing molds one by one for the models of mobile phones that are continuously and variously changed or without an increase of the thickness of the mobile phone by a separate attachment protruding outward due to the mobile phone support configuration.

A band insertion groove is formed on the inner surface of the band support plate between the band insertion holes so that the band inserted in the band insertion holes is seated in the band insertion groove.

Further, a decorative pattern is attached around the band support plate and the support plate insertion hole of the mobile phone or mobile phone case, so decoration can be presented.

### TECHNICAL FIELD

The present disclosure relates to a mobile phone safety device that enables a user to easily hold a mobile phone or a mobile PC device such as a tablet PC to be able to more stably carry and use the mobile phones, etc.

### BACKGROUND ART

Recently, as mobile phones are rapidly developed and popularized,

it is possible not only to use voice and video calls and text messages, but also search various items of information, watch DMB or YouTube, and play games, etc. without limitation in time and space around the world.

Further, as the camera function is developed, high-quality photographing is possible, so it is common to take pictures using mobile phones.

Such functions of mobile phones are expected to be further improved in the future, so a mobile phone is being positioned as a necessity that modern people are unwilling to keep away from even for a while.

Meanwhile, expensive mobile phones having new functions continuously come into the market with development of mobile phones and customers periodically purchase new models on an installment plan with communication companies.

Accordingly, customers very carefully use mobile phones that they purchased at high prices not to loose or damage the mobile phones.

Further, they cover their mobile phones with a case, etc. to prevent the mobile phones from breaking when dropped.

However, existing mobile phone cases simply cover only the outside of mobile phones and do not have a configuration for safely supporting mobile phones or the mobile phone cases.

Accordingly, it is very inconvenient to operate a mobile phone while touching the screen with a thumb with the mobile phone in a hand when using the mobile phone. Further, when a user drops a mobile phone by mistake, the liquid crystal screen of the mobile phone is cracked or the surface is scratched even though the mobile phone is covered with a case.

In order to solve this problem, a product having a string fastened to a corner of a mobile phone case such that a user winds the string on a wrist to prevent the mobile phone from separating from the hand, or

a product that can support a mobile phone when the mobile phone is used by bonding and fixing a narrow band, chain, or circular ring to the rear side of a mobile phone case using a double-sided tape has been disclosed.

However, according to the former, since a mobile phone is wound around a wrist, it is very inconvenient to touch and operate the screen of the mobile phone.

According to the latter, since the configuration for supporting a mobile phone is mostly a ring or a chain made of a plastic mold or a metallic material and is attached to the rear side of the mobile phone case by a specific fastener or a double-sided tape,

the supporting configuration thickly protrudes outside from the mobile phone case. Accordingly, it cannot satisfy the preference of customers who want as thin mobile phone as possible, so they avoid using this product.

### DISCLOSURE

### Technical Problem

The present disclosure has been made in consideration of general problems of mobile phone supporting products of the related art and

an objective of the present disclosure is to provide a device for safely supporting a mobile phone that enables customers to present their more aesthetic and individual decoration by giving a decorative function in addition to a mobile phone support function.

Another objective of the present disclosure is to provide a device for safely supporting a mobile phone that more easily and stably supports a mobile phone and does not influence the thickness of the mobile phone.

Another objective of the present disclosure is to provide a device for safely supporting a mobile phone that makes it possible to apply mobile phone support configurations to mobile phones or mobile phone cases without manufacturing molds one by one in accordance with the models of mobile phones which are continuously and variously changed.

### Technical Solution

To this end, according to the present disclosure,

one or more of a connection ring, a connection string, and beads are selectively separably connected to a band for supporting a mobile phone with a finger inserted therein, so a user can present his/her more individual and aesthetic decoration.

Further, a support plate insertion hole for applying a mobile phone support configuration is formed at the center of the rear side of an existing mobile phone or mobile phone case such that a band support plate having the band insertion hole for inserting the band is inserted and supported by a locking step formed at the support plate insertion hole or the band support plate.

Accordingly, it is possible to more easily support and use a mobile phone equipped with the mobile phone support configuration while keeping the mobile phone thin without manufacturing molds one by one for the models of mobile phones that are continuously and variously changed or without an increase of the thickness of the mobile phone by a separate attachment protruding outward due to the mobile phone support configuration.

A band insertion groove is formed on the inner surface of the band support plate between the band insertion holes so that the band inserted in the band insertion holes is seated in the band insertion groove.

Further, a decorative pattern is attached around the band support plate and the support plate insertion hole of the mobile phone or mobile phone case, so decoration can be presented.

### Advantageous Effects

According to the device for safely supporting a mobile phone of the present disclosure,

a decorative function is given to a mobile phone support configuration so that customers can present their more aesthetic and individual decoration.

Further, a support plate insertion hole for applying a mobile phone support configuration is formed at an existing mobile phone or mobile phone case so that a band support plate having a band insertion hole for inserting a band can be inserted.

Accordingly, there is an effect that it is possible to more easily support and use a mobile phone equipped with the mobile phone support configuration while keeping the mobile phone thin without manufacturing molds one by one for the models of mobile phones that are continuously and variously changed or without an increase of the thickness of the mobile phone by a separate attachment protruding outward due to the mobile phone support configuration.

### DESCRIPTION OF DRAWINGS

FIG. 1 is an external appearance view of an embodiment of a device for safely supporting a mobile phone of the present disclosure;

FIG. 2 is a horizontal cross-sectional view of the same part;

FIG. 3 is an external appearance view and a cross-sectional view showing a configuration state of a band support plate mounted on the present disclosure;

FIGS. 4 to 7 are partial horizontal cross-sectional view of several embodiments of the present disclosure; and

FIGS. 8 and 9 are external appearance views showing the state in which symbolic patterns of a band support plate mounted on the present disclosure are applied.

### BEST MODE

Exemplary embodiments of the present disclosure are described hereafter in detail with reference to the accompanying drawings.

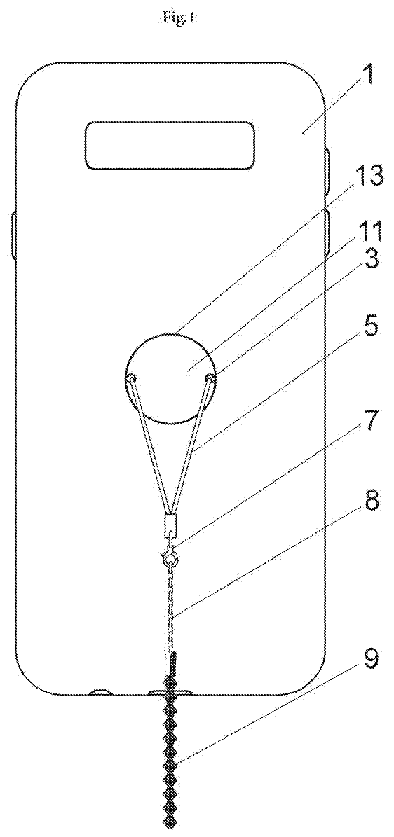

FIG. 1 is an external appearance view of an embodiment of a device for safely supporting a mobile phone of the present disclosure.

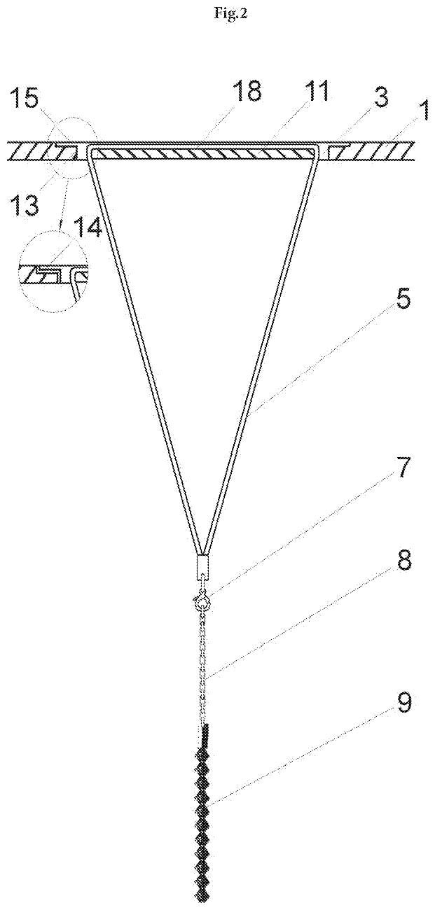

FIG. 2 is a horizontal cross-sectional view of the same part.

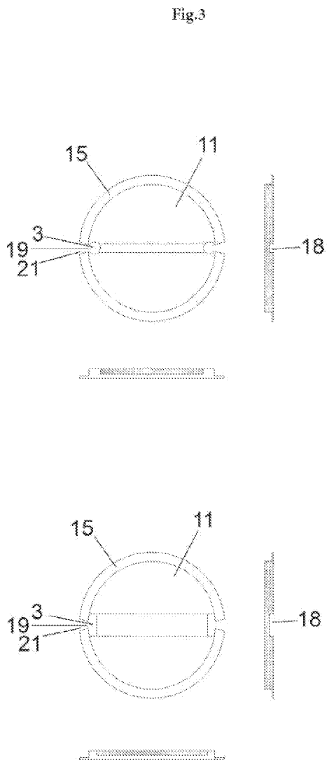

FIG. 3 is an external appearance view and a cross-sectional view showing a configuration state of a band support plate mounted on the present disclosure.

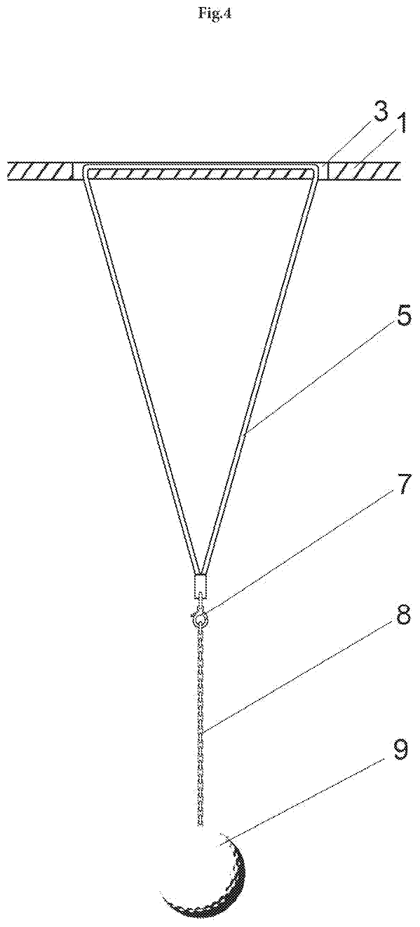

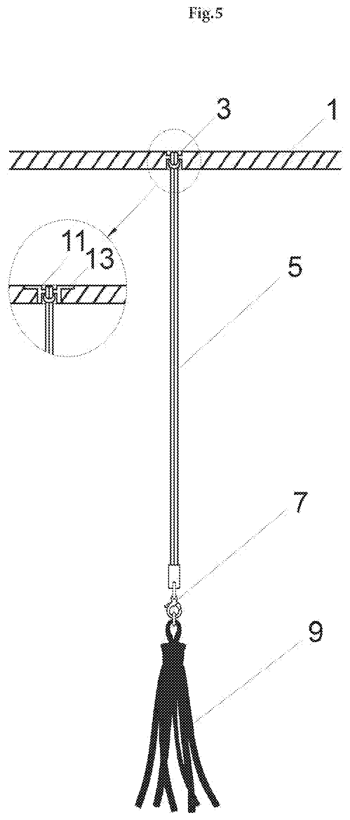

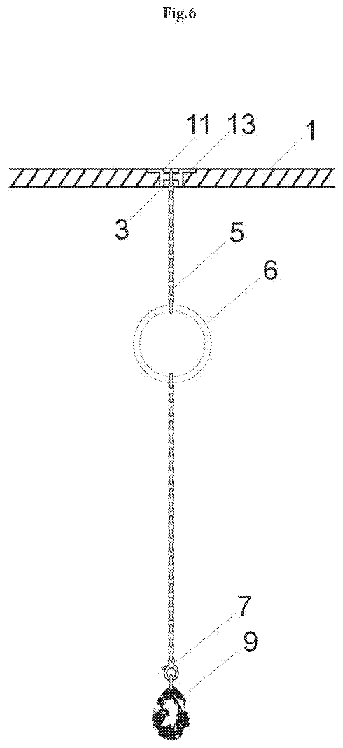

FIGS. 4 to 7 are partial horizontal cross-sectional view of several embodiments of the present disclosure.

According to a device for safely supporting a mobile phone of the present disclosure,

one or more band insertion holes 3 are formed at the center of the rear side of a mobile phone or a mobile phone case 1.

A string or chain made of elastic or non-elastic fabric, synthetic resin, rubber, or metal, or narrow band 5 (hereafter, referred to as a band) is inserted in the band insertion hole 3.

A ring 6 or one or more of a connection ring 7 having various shapes, colors, and materials, a connection string 8, and an accessory 9 such as various craft items, external memory devices, and wireless earphone cases are selectively detachably connected to the band 5.

A user can safely carry and use a mobile phone with fingers in the band 5 or the ring 6.

A user can individually present his/her own aesthetic sense by freely replacing the band 5, connection ring 7, connection string 8, and accessories 9 in accordance with his/her preference.

The band insertion hole 3 may be formed at the center of the rear side of a mobile phone or the mobile phone case 1 simultaneously in injection molding or may be formed at a separate band support plate 11 and then a support plate insertion hole 13 may be formed at the center of the rear side of a mobile phone or the mobile phone case 1, and then the band support plate 11 may be inserted in the support plate insertion hole 13.

When the support plate insertion hole 13 and the band support plate 11 are fitted to each other, they are manufactured in any shapes that can be fitted to each other, so they are fixed in close contact with each other or are separated from each other.

Accordingly, when the support plate insertion hole 13 and the band support plate 11 are formed in circular shapes, the band support plate 11 can be rotated along the inner surface of the support plate insertion hole 13. Therefore, when a mobile phone is used, the band 5 inserted in the band insertion hole 3 of the band support plate 11 can be more smoothly moved without winding or twisting.

An assistant ring 14 is additionally inserted inside the inner surface of the support plate insertion hole 13, whereby friction with the band support plate 11 is reduced and the band support plate 11 can be more smoothly rotated.

The band support plate 11 is mounted not to separate out of the support plate insertion hole 13 by a locking step 15 formed at the band support plate 11 or the support plate insertion hole 13.

The band support plate 11 may be inserted and installed in a support plate insertion hole 13′ of a support plate case 17 attached to the center of the rear side of a mobile phone or the mobile phone case 1.

The support plate insertion hole 13 may be formed simultaneously when a mobile phone of the mobile phone case 1 is injection-molded, or

may be formed at the center of a mobile phone or the mobile phone case, which has been formed, by pressing or cutting. Accordingly, it is not required to separately manufacture a mobile phone or mobile phone case having the support plate insertion hole 13 for each of mobile phone models.

When the band insertion hole 3 is formed at the band support plate 11, a plurality of band insertion holes may be formed to face each other outside the band support plate 11.

A band insertion groove 18 is formed on the inner surface of the band support plate 11 between the band insertion holes 3, so a string or chain or a narrow hand 5 inserted in the band insertion hole 3 is stably inserted in the band insertion groove 18.

An opening 21 selectively having a tapered portion 19 is formed at the band insertion hole 3, so the band 5 that is inserted in the band insertion hole 3 can be easily inserted through the opening 21 and is not easily separated by the tapered portion 19 after inserted.

According to the device for safely supporting a mobile phone having this configuration of the present disclosure, as shown in FIG. 1, a string or chain made of elastic or non-elastic fabric, synthetic resin, rubber, or metal or a narrow band 5 is fitted in one or more band insertion holes 3 formed at the center of the rear side of a mobile phone or the mobile phone case 1.

Accordingly, when a user holds or puts a mobile phone or the mobile phone case 1 on a palm with a pointer finger or middle finger inserted in the band 5 formed at the center of the rear side of the mobile phone or the mobile phone case to use the mobile phone or take a picture,

the mobile phone or the mobile phone case 1 is not unexpectedly separated from the hand by the band 5. Therefore, there is no possible of dropping the mobile phone while staying at a place or walking, so it is possible to use the mobile phone at ease.

Further, since the band 5 is positioned on the center of the rear side of a mobile phone or the mobile phone case 1, the center of gravity of the mobile phone is horizontally maintained, so the mobile phone can be stably supported even by one of a pointer finger and a middle finger.

The mobile phone is additionally supported by the other fingers except for the pointer finger or the middle finger inserted in the band and it is very easy to operate the mobile phone screen with a thumb, so there is an effect that it is possible to stably carry and use the mobile phone at ease with one hand without the possibility of dropping the mobile phone.

According to the device for safely supporting a mobile phone of the present disclosure, since one or more of a connection ring 7 having various shapes, colors, and materials, a connection string 8, and an accessory 9 such as various craft items, external memory devices, and wireless earphone cases are selectively detachably connected to the band 5,

there is an advantage that a user can individually present his/her own aesthetic sense by freely replacing the band 5, the connection ring 7, the connection string 8, and the accessory 9 in accordance with high/her preference or necessity.

According to the device for safely supporting a mobile phone of the present disclosure, the band insertion hole 3 is formed at the center of the rear side of a mobile phone or a mobile phone case 1 simultaneously with injection molding.

Alternatively, as shown in FIG. 2, the band insertion hole 3 is formed at the separate band support plate 11 and then the band support plate 11 having the band insertion hole 3 is inserted into the support plate insertion hole 13 formed at the center of the rear side of the mobile phone or the mobile phone case 1 such that the band support plate 11 is not separated out of the support plate insertion hole 13 by the locking step 15 formed at the band support plate 11 or the support plate insertion hole 13.

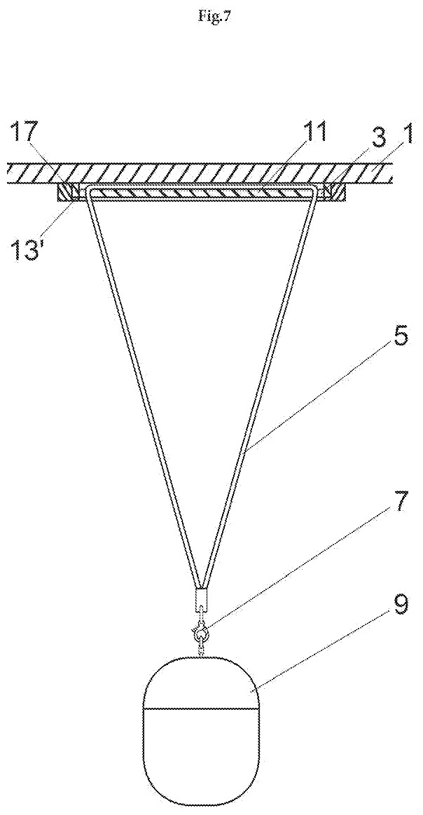

Alternatively, as shown in FIG. 7, the band support plate 11 may be inserted in the support plate insertion hole 13′ of the support plate case 17 attached to the center of the rear side of a mobile phone or the mobile phone case 1.

Accordingly, the band insertion hole 3 can be formed in various ways, so there is an effect that it is possible to considerably decrease the manufacturing cost.

Alternatively, the support plate insertion hole 13 may also be formed at the center of the rear side of a mobile phone or the mobile phone case 1 simultaneously with injection molding of the mobile phone or the mobile phone case.

However, by additionally forming the support plate insertion hole 13 at a mobile phone or the mobile phone 1 that has been formed through pressing or cutting, as shown in FIG. 2,

it is not required to individually manufacture mobile phone or mobile phone case molds, which has the support plate insertion hole 13, one by one for mobile phone models in order to form the support plate insertion hole 13. Accordingly, there is an advantage that it is possible to easily apply the device for supporting a mobile phone to existing mobile phones or mobile phone cases even without manufacturing molds one by one for the models of mobile phones that are continuously changed.

The support plate insertion holes 13 and 13′ and the band support plate 11 of the present disclosure can be formed in any shapes that are fitted to each other when they are fitted to each other.

Further, when the support plate insertion holes 13 and 13′ and the band support plate 11 formed in circular shapes, the band support plate 11 can be rotated along the inner surfaces of the support plate insertion holes 13 and 13′.

Accordingly, in the case that a user wants to turn a mobile phone to watch DMB or YouTube or take a picture while using the mobile phone,

when the user turns the mobile phone in a desired direction with a finger inserted in the band 5,

the mobile phone case 1 is easily rotated about the band 5 or the band support plate 7 connected with the band 5. Accordingly, there is an advantage that it is possible to more smoothly operate the mobile phone in a desired direction without the band 5 inserted in the band insertion hole 3 of the band support plate 11 winding or twisting.

Further, when the band insertion hole 3 is formed at the band support plate 11, as shown in FIG. 3, a plurality of band insertion holes 3 are formed outside the band support plate 11 to face each other and the band 5 is seated and operated in the band insertion groove 18 formed on the inner surface of the band support plate 11 between the band insertion holes 3,

whereby there is an effect that the band 5 can be more smoothly operated.

Further, an opening 21 selectively having a tapered portion 19 is formed at the band insertion hole 3,

so the band 5 that is inserted in the band insertion hole 3 can be easily inserted through the opening 21 and is not easily separated by the tapered portion 19 after inserted.

### Mode for Invention

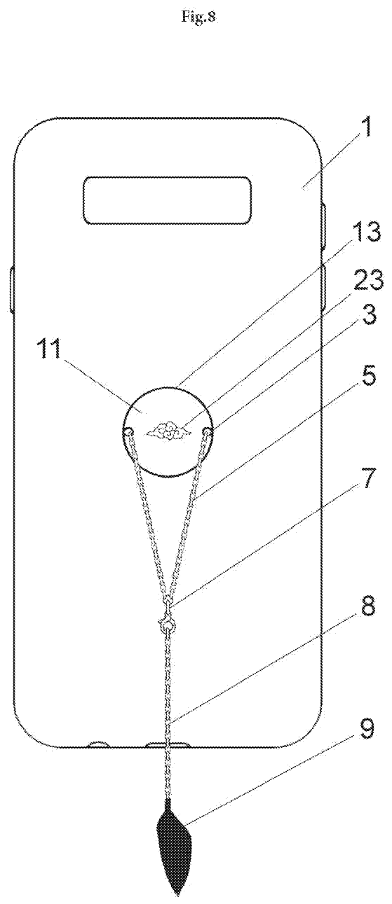

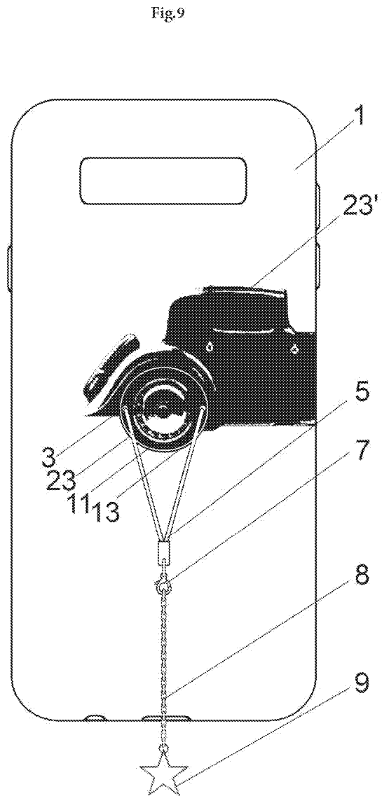

FIGS. 8 and 9 are external appearance views showing the state in which symbolic patterns of a band support plate mounted on the present disclosure are applied.

As shown in FIG. 8, the band support plate 11 is formed without a pattern, or a decorative pattern 23 such as a specific pattern, an initial, a logo, and a desired text of a user (hereafter, referred to as a decorative pattern) is engraved in relief, engraved in intaglio, or cut or printed flat, whereby decorative beauty can be presented.

As shown in FIG. 9, a decorative pattern 23′ related to the band support plate 11 is applied around the support plate insertion holes 13 and 13′ of a mobile phone or the mobile phone case 1 so that decorative beauty related to the band support plate 11 or the decorative pattern 23 of the band support plate 11 can be presented.

Therefore, according to the device for safely supporting a mobile phone of the present disclosure,

one or more of the connection ring 7, the connection string 8, and the accessory 9 are selectively separably connected to the band 5 for supporting a mobile phone with a finger inserted therein, so a user can present his/her more individual and aesthetic decoration.

The support plate insertion hole 13 for applying a mobile phone support configuration is formed at the center of the rear side of an existing mobile phone or mobile phone case 1 such that the band support plate 11 having the band insertion hole 3 for inserting the band 5 is inserted and supported by the locking step 15 formed at the support plate insertion hole 13 or the band support plate 11.

Accordingly, it is possible to more easily support and use a mobile phone equipped with the mobile phone support configuration while keeping the mobile phone thin without manufacturing molds one by one for the models of mobile phones that are continuously and variously changed or without an increase of the thickness of the mobile phone by a separate attachment protruding outward due to the mobile phone support configuration.

The band insertion groove 18 is formed on the inner surface of the band support plate 11 between the band insertion holes 3 so that the band 5 inserted in the band insertion holes 3 is seated in the band insertion groove 18.

The decorative patterns 23 and 23′ are attached around the band support plate 11 and the support plate insertion hole 13 of the mobile phone or mobile phone case 1, so there is an advantage that more various decorations can be presented.

Although the present disclosure was described above with reference to a specific embodiment,

the embodiment is an example for describing the spirit of the present disclosure, and

the scope of the present disclosure is not limited to the embodiment and includes all changes within equivalent meaning and range of claims to the spirit of the present disclosure.

### INDUSTRIAL APPLICABILITY

The device for safely supporting a mobile phone of the present disclosure

can be used to enable a user to easily hold a mobile phone or a mobile PC device such as a tablet PC to be able to more stably carry and use the mobile phones, etc. and

to enable customers to present their more aesthetic and individual decoration by giving a decorative function to the device.

1. A device for safely supporting a mobile phone, wherein a band (5) to which a ring (6) or one or more of a connection ring, a connection string, and an accessory (9) are selectively separably connected is inserted in one or more band insertion holes (3) formed at a center of a rear side of a mobile phone or a mobile phone case (1) so that a user can present his/her individual decoration and the mobile phone can be stably carried and used with a finger inserted in the band (5) or the ring (6) and supporting the mobile phone.

2. The device of claim 1, wherein one or more band insertion holes (3) are formed at a band support plate (11) or a support plate insertion hole (13) is formed at a center of the rear side of the mobile phone or the mobile phone case (1), and the band support plate (11) inserted in the support plate insertion hole (13) is supported by a locking step (15) formed at the band support plate (11) or the support plate insertion hole (13).

3. The device of claim 2, wherein the band support plate (11) is inserted and installed in a support plate insertion hole (13′) of a support plate case (17) attached to a center of the rear side of the mobile phone or the mobile phone case (1).

4. The device of claim 2 or 3, wherein the support plate insertion hole (13, 13′) and the band support plate (11) are formed in circular shapes such that the band support plate (11) is rotated along an inner surface of the support plate insertion hole (13, 13′).

5. The device of claim 2 or 3, wherein a plurality of band insertion holes (3) is formed to face each other outside the band support plate (11).

6. The device of claim 5, wherein a band insertion groove (18) is formed on an inner surface of the band support plate (11) between the band insertion holes (3) so that the band (5) inserted in the band insertion holes (3) is seated in the band insertion groove (18).

7. The device of claim 2 or 3, wherein an opening (21) selectively having a tapered portion (19) is formed at the band insertion hole (3) so that the band (5) is inserted through the opening (21).

8. The device of claim 2 or 3, wherein a decorative pattern (23) is formed at the band support plate (11) so that decoration can be presented.

9. The device of claim 2 or 3, wherein a decorative pattern (23′) related to the band support plate (11) is given around the support plate insertion hole (13, 13′) so decoration related to the band support plate (11) or a decorative pattern (23) of the band support plate (11) can be presented.

10. The device of claim 2 or 3, wherein an assistant ring (14) is additionally inserted inside an inner surface of the support plate insertion hole (13, 13′), thereby reducing friction with the band support plate (11) so that the band support plate (11) can be smoothly rotated.
